(19) United States
(12) Patent Application Publication
(10) Pub. No.: US 2019/0339721 A1
(43) Pub. Date: Nov. 7, 2019

(54) FLIGHT DIRECTION CORRECTION METHOD FOR UNMANNED AERIAL VEHICLE, CONTROL METHOD FOR UNMANNED AERIAL VEHICLE, AND UNMANNED AERIAL VEHICLE

(71) Applicants: Beijing Jingdong Shangke Information Technology Co., Ltd., Beijing (CN); Beijing Jingdong Century Trading Co., Ltd., Beijing (CN)

(72) Inventor: Song Han, Beijing (CN)

(73) Assignees: Beijing Jingdong Shangke Information Technology Co., Ltd., Beijing (CN); Beijing Jingdong Century Trading Co., Ltd., Beijing (CN)

(21) Appl. No.: 16/314,597

(22) PCT Filed: Jun. 29, 2017
(86) PCT No.: PCT/CN2017/090777

§ 371 Date: Apr. 17, 2019

(30) Foreign Application Priority Data
Jul. 4, 2016 (CN) 201610519394.0

(51) Int. Cl. G05D 1/10; B64C 39/02

(52) U.S. Cl. CPC G05D 1/106; B64C 2201/128; B64C 2201/141; B64C 39/024

(57) ABSTRACT

A flight direction correction method for an unmanned aerial vehicle, a control method for an unmanned aerial vehicle, and the unmanned aerial vehicle, mainly solving the problem of a complex correction method in the prior art. The flight direction correction method for an unmanned aerial vehicle comprises: obtaining, at every interval of a predetermined time T, the position of an unmanned aerial vehicle in a straight flight path section; correcting the flight direction of the unmanned aerial vehicle according to the position of the unmanned aerial vehicle obtained at the preceding time, the position of the unmanned aerial vehicle obtained at the current time, and the ending point position of the straight flight path section where the position of the unmanned aerial vehicle at the current time is located. The flight direction correction method for an unmanned aerial vehicle determines the degree of deviation of the current position according to the position of the unmanned aerial vehicle obtained at the preceding time, the position of the unmanned aerial vehicle obtained at the current time, and the ending point position of the straight flight path section where the position of the unmanned aerial vehicle at the current time is located, and adjusts the flight direction of the unmanned aerial vehicle, correcting the flight direction by means of the unmanned aerial vehicle itself, and by way of using a two-end control method, the method being simple, and the adjustment efficiency and accuracy being high.

### CROSS-REFERENCE TO RELATED APPLICATIONS

This application claims the priority to Chinese Patent Application No. 201610519394.0 filed on Jul. 4, 2016, the disclosure of which is hereby incorporated by reference in its entirety.

### TECHNICAL FIELD

The present disclosure relates to the field of unmanned aerial vehicle, specifically relates to a flight direction correction method for an unmanned aerial vehicle, a control method for an unmanned aerial vehicle, and the unmanned aerial vehicle.

### BACKGROUND

With the rapid development of the Internet, online shopping becomes very popular, particularly in the first- and second-tier cities, but also is spreading to the third- and fourth-tier cities as well as rural towns and villages. However, in rural towns and villages, e-commerce has just started and people's shopping habits have not fully developed. The quantity of the orders is still relatively small, directly increasing the delivery costs of packages. Therefore, in some places, a method to deliver packages through unmanned aerial vehicles has been developed.

Unmanned aerial vehicles typically adopt automatic navigation during flights, and fly according to specific flight paths. However, due to factors such as environment and external forces (wind), the flight direction of an unmanned aerial vehicle may deviate. Therefore, to guarantee the accuracy of the flight path of the unmanned aerial vehicle, constant corrections to the flight direction are required. In the prior art, a method of mutually notifying the flight coverage among clustered unmanned aerial vehicles is used to adjust the direction. This correction method is complicated, having high configuration requirements, and is low in adjustment efficiency and accuracy.

### SUMMARY

In view of this, the present disclosure provides a simple and highly efficient flight direction correction method for an unmanned aerial vehicle.

To achieve this objective, the present disclosure adopts the following technical solution.

A flight direction correction method for an unmanned aerial vehicle, a flight path of the unmanned aerial vehicle including a plurality of straight flight path sections, the method including: obtaining, at every interval of a predetermined time T, a position of the unmanned aerial vehicle in a straight flight path section; and correcting a flight direction of the unmanned aerial vehicle according to a position of the unmanned aerial vehicle obtained at a preceding time, a position of the unmanned aerial vehicle obtained at a current time, and an end position of the straight flight path section encompassing the position of the unmanned aerial vehicle at the current time.

Preferably, the method includes: establishing a Cartesian coordinate system I perpendicular to a height direction, and obtaining coordinates (xᵢ₋₁, yᵢ₋₁) of the position of the unmanned aerial vehicle obtained at the preceding time in the Cartesian coordinate system I, coordinates (xᵢ, yᵢ) of the position of the unmanned aerial vehicle obtained at the current time in the Cartesian coordinate system I and coordinates (x_{b}, y_{b}) of the end position of the straight flight path section encompassing the position of the unmanned aerial vehicle at the current time in the Cartesian coordinate system I; and correcting the flight direction of the unmanned aerial vehicle based on the coordinates (xᵢ₋₁, yᵢ₋₁) of the position at the preceding time, the coordinates (xᵢ, yᵢ) of the position at the current time and the coordinates (x_{b}, y_{b}) of the end position.

Preferably, a connection line between the coordinates (xᵢ, yᵢ) of the position at the current time and the coordinates (xᵢ₋₁, yᵢ₋₁) of the position at the preceding time is defined as L₁ and a connection line between the coordinates (xᵢ, yᵢ) of the position at the current time and the coordinates (x_{b}, y_{b}) of the end position is defined as L₂; the correcting the flight direction of the unmanned aerial vehicle based on the coordinates (xᵢ₋₁, yᵢ₋₁) of the position at the preceding time, the coordinates (xᵢ, yᵢ) of the position at the current time and the coordinates (x_{b}, y_{b}) of the end position includes: obtaining an angle αᵢ between L₁ and a horizontal axis of the Cartesian coordinate system I, and an angle βᵢ between L₂ and the horizontal axis of the Cartesian coordinate system I; and deflecting the flight direction of the unmanned aerial vehicle by an angle |αᵢ−βᵢ| to the end position.

Preferably, a connection line between the coordinates (xᵢ₋₁, yᵢ₋₁) of the position at the preceding time and the coordinates (x_{b}, y_{b}) of the end position is defined as L₃; the deflecting the flight direction of the unmanned aerial vehicle by an angle |αᵢ−βᵢ| to the end position includes: wherein, when a slope of L₁ is positive, if a slope of L₃ is less than the slope of L₁, the flight direction of the unmanned aerial vehicle is deflected clockwise, and if the slope of L₃ is greater than the slope of L₁, the flight direction of the unmanned aerial vehicle is deflected counter clockwise; and when the slope of L₁ is negative, if the slope of L₃ is greater than the slope of L₁, the flight direction of the unmanned aerial vehicle is deflected clockwise, and if the slope of L₃ is less than the slope of L₁, the flight direction of the unmanned aerial vehicle is deflected counterclockwise.

Preferably, before the deflecting the flight direction of the unmanned aerial vehicle, determining whether |αᵢ−βᵢ| is greater than or equal to a predetermined value θ, if |αᵢ−βᵢ| is greater than or equal to the predetermined value θ, the flight direction of the unmanned aerial vehicle is deflected by the angle |αᵢ−βᵢ| to the end position, if |αᵢ−βᵢ| is less than the predetermined value θ, no deflection is performed.

Preferably, in a straight flight path section, at a first predetermined distance from an end point of the straight flight path section, the predetermined time T is reduced; and/or at a second predetermined distance from an end point of the entire flight path of the unmanned aerial vehicle, the predetermined time T is reduced.

Preferably, the unmanned aerial vehicle changes the flight direction when an obstacle is detected, and the flight direction of the unmanned aerial vehicle is corrected using the correction method, after detecting bypassing the obstacle.

The present disclosure further provides a control method for an unmanned aerial vehicle using the above correction method, which improves the accuracy of the flight path of the unmanned aerial vehicle and the flight reliability.

To achieve this objective, the present disclosure adopts the following technical solution.

A control method for an unmanned aerial vehicle, the method including: developing a flight path for the unmanned aerial vehicle based on coordinates of a target position and current coordinates; and flying according to the developed flight path and correcting a flight direction of the unmanned aerial vehicle according to the above correction method.

Preferably, the developed flight path includes a plurality of straight flight path sections, and the flying according to the developed flight path includes: establishing a Cartesian coordinate system I perpendicular to a height direction, and obtaining coordinates (xₐ₁, yₐ₁) of a starting point of a first straight flight path section of the flight path in the Cartesian coordinate system I and coordinates (x_{b1}, y_{b1}) of an end point of the first straight flight path section in the Cartesian coordinate system I; and obtaining an initial flight direction of the unmanned aerial vehicle based on the coordinates (xₐ₁, yₐ₁) of the starting point and the coordinates (x_{b1}, y_{b1}) of the end point, and flying according to the obtained initial flight direction.

Preferably, the flying according to the developed flight path further includes: when the unmanned aerial vehicle reaches a joint point with an adjacent straight flight path section, a connection line between coordinates of a starting point of a preceding straight flight path section in the Cartesian coordinate system I and coordinates of an end point of the preceding straight flight path section in the Cartesian coordinate system I is defined as Lᵢ, a connection line between coordinates of a starting point of a subsequent straight flight path section in the Cartesian coordinate system I and coordinates of an end point of the subsequent straight flight path section in the Cartesian coordinate system I is defined as Lᵢ₊₁, obtaining an angle δᵢ between L₁ and a horizontal axis of the Cartesian coordinate system I and an angle δᵢ₊₁ between Lᵢ₊₁ and the horizontal axis of the Cartesian coordinate system I, deflecting the flight direction of the unmanned aerial vehicle to a position of the end point of the subsequent straight flight path section by an angle of δᵢ+δᵢ₊₁ to enter the subsequent straight flight path section.

Preferably, the method further includes: receiving an instruction from a first remote controller to take off; and reaching the target position, and receiving an instruction from a second remote controller to land.

The present disclosure further provides an unmanned aerial vehicle capable of conveniently, quickly and easily performing flight direction correction.

To achieve this objective, the present disclosure adopts the following technical solution.

An unmanned aerial vehicle, including: a positioning apparatus, configured to obtain, at every interval of a predetermined time T, a position of the unmanned aerial vehicle; a processing apparatus, storing flight path information of the unmanned aerial vehicle, a flight path including a plurality of straight flight path sections, and the processing apparatus is configured to correct a flight direction of the unmanned aerial vehicle according to a position of the unmanned aerial vehicle obtained at a preceding time, a position of the unmanned aerial vehicle obtained at a current time, and an end position of a straight flight path section encompassing the position of the unmanned aerial vehicle at the current time.

The beneficial effects of the present disclosure are as follows.

The flight direction correction method for an unmanned aerial vehicle provided by the present disclosure determines the degree of deviation of the current position according to the position of the unmanned aerial vehicle obtained at the preceding time, the position of the unmanned aerial vehicle obtained at the current time, and the end position of the straight flight path section encompassing the position of the unmanned aerial vehicle at the current time, and adjusts the flight direction of the unmanned aerial vehicle, thereby correcting the flight direction by means of the unmanned aerial vehicle by itself. By way of using a two-end control method, the method is simple, and the adjustment efficiency and accuracy are high.

The control method for an unmanned aerial vehicle provided by the present disclosure uses the above correction method to correct the flight direction, and has high flight reliability and accurate flight path.

The control method for an unmanned aerial vehicle provided by the present disclosure uses a remote controller to control at the take-off end and the landing end, and adopts an automatic navigation flight during the flight, which has high reliability and accurate flight path.

The unmanned aerial vehicle provided by the present disclosure can automatically locate its current position and correct the flight direction of the unmanned aerial vehicle according to the position of the unmanned aerial vehicle obtained at the preceding time, the position of the unmanned aerial vehicle obtained at the current time, and the end position of the straight flight path section encompassing the position of the unmanned aerial vehicle at the current time, and correct the flight direction by means of the unmanned aerial vehicle itself. The method is simple, and the adjustment efficiency and accuracy are high.

### BRIEF DESCRIPTION OF THE DRAWINGS

After reading detailed descriptions of embodiments of the present disclosure with reference to the following accompanying drawings, the above and other objectives, features and advantages of the present disclosure will become more apparent. In the accompanying drawings:

FIG. 1 is a flowchart of a flight direction correction method for an unmanned aerial vehicle according to embodiments of the present disclosure;

FIG. 2 is a first schematic diagram of correcting a direction of an unmanned aerial vehicle according to embodiments of the present disclosure;

FIG. 3 is a second schematic diagram of correcting a direction of an unmanned aerial vehicle according to embodiments of the present disclosure;

FIG. 4 is a first schematic diagram of the flight direction correction method for an unmanned aerial vehicle applied to avoid obstacles according to embodiments of the present disclosure;

FIG. 5 is a second schematic diagram of the flight direction correction method for an unmanned aerial vehicle applied to avoid obstacles according to embodiments of the present disclosure; and

FIG. 6 is a flowchart of a control method for an unmanned aerial vehicle according to embodiments of the present disclosure.

### DETAILED DESCRIPTION OF EMBODIMENTS

The present disclosure is described below based on the embodiments, but the present disclosure is not limited by these embodiments. In the following detailed description of the present disclosure, some specific detailed parts are described in detail. The present disclosure may be fully understood by those skilled in the art without a description of these details. In order to avoid obscuring the essence of the present disclosure, well-known methods, processes, procedures, and elements are not described in detail.

The present disclosure provides a flight direction correction method for an unmanned aerial vehicle, a flight path of the unmanned aerial vehicle including a plurality of straight flight path sections, and the method includes: obtaining, at every interval of a predetermined time T, the position of an unmanned aerial vehicle in a straight flight path section; and correcting the flight direction of the unmanned aerial vehicle according to the position of the unmanned aerial vehicle obtained at the preceding time, the position of the unmanned aerial vehicle obtained at the current time, and the end position of the straight flight path section encompassing the position of the unmanned aerial vehicle at the current time. By correcting the flight direction of the unmanned aerial vehicle according to the position of the unmanned aerial vehicle obtained at the preceding time, the position of the unmanned aerial vehicle obtained at the current time, and the end position of the straight flight path section encompassing the position of the unmanned aerial vehicle at the current time, the unmanned aerial vehicle may correct the flight direction by itself. The two-end control method is simple, and the adjustment efficiency and accuracy are high.

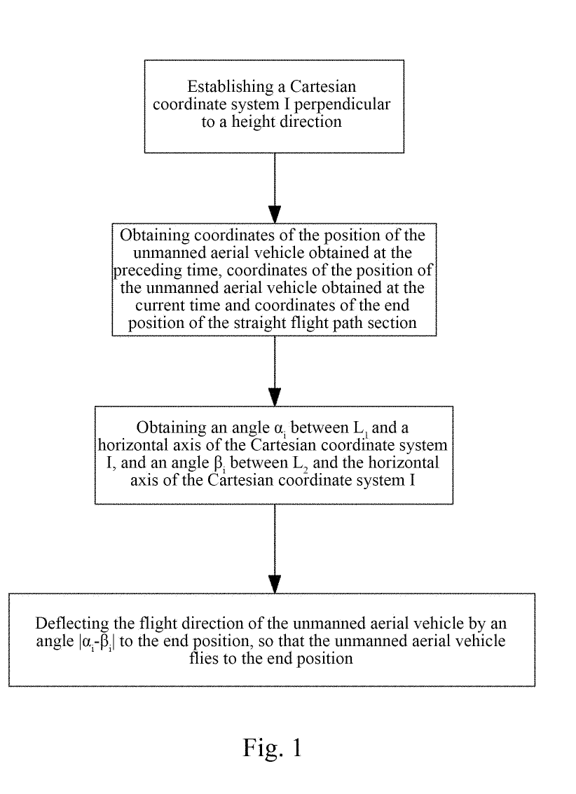

With reference to FIG. 1, an embodiment of a flight direction correction method for an unmanned aerial vehicle according to the present disclosure is illustrated.

The flight path of an unmanned aerial vehicle is composed of a plurality of straight flight path sections. When the unmanned aerial vehicle flies to the joint point of two straight flight path sections, the unmanned aerial vehicle changes the flight direction to enter the next straight flight path section. When the unmanned aerial vehicle is in a certain straight flight path section, the flight direction may deviate due to factors such as the environment. Therefore, it is necessary to correct the flight direction.

As shown in FIG. 1, the flight direction correction method for an unmanned aerial vehicle according to the specific embodiments of the present disclosure includes the following steps.

Establishing a Cartesian coordinate system I perpendicular to a height direction, and obtaining coordinates (xᵢ₋₁, yᵢ₋₁) of the position of the unmanned aerial vehicle obtained at the preceding time in the Cartesian coordinate system I, coordinates (xᵢ, yᵢ) of the position of the unmanned aerial vehicle obtained at the current time in the Cartesian coordinate system I and coordinates (x_{b}, y_{b}) of the end position of the straight flight path section encompassing the position of the unmanned aerial vehicle at the current time in the Cartesian coordinate system I.

Correcting the flight direction of the unmanned aerial vehicle based on the coordinates (xᵢ₋₁, yᵢ₋₁) of the position at the preceding time, the coordinates (xᵢ, yᵢ) of the position at the current time and the coordinates (x_{b}, y_{b}) of the end position.

For convenience of description, a connection line between the coordinates (xᵢ, yᵢ) of the position at the current time and the coordinates (xᵢ₋₁, yᵢ₋₁) of the position at the preceding time is defined as L₁, a connection line between the coordinates (xᵢ, yᵢ) of the position at the current time and the coordinates (x_{b}, y_{b}) of the end position is defined as L₂, and a connection line between the coordinates (xᵢ₋₁, yᵢ₋₁) of the position at the preceding time and the coordinates (x_{b}, y_{b}) of the end position is defined as L₃.

In a preferred embodiment, the correcting the flight direction of the unmanned aerial vehicle based on the coordinates (xᵢ₋₁, yᵢ₋₁) of the position at the preceding time, the coordinates (xᵢ, yᵢ) of the position at the current time and the coordinates (x_{b}, y_{b}) of the end position includes: obtaining an angle αᵢ between L₁ and a horizontal axis of the Cartesian coordinate system I, and an angle βᵢ between L₂ and the horizontal axis of the Cartesian coordinate system I; and deflecting the flight direction of the unmanned aerial vehicle by an angle |αᵢ−βᵢ| to the end position, so that the unmanned aerial vehicle flies to the end position.

Here, the specific method for deflecting the flight direction of the unmanned aerial vehicle to the end position is as follows.

When a slope of L₁ is positive, if a slope of L₃ is less than the slope of L₁, the flight direction of the unmanned aerial vehicle is deflected clockwise, and if the slope of L₃ is greater than the slope of L₁, the flight direction of the unmanned aerial vehicle is deflected counterclockwise.

When the slope of L₁ is negative, if the slope of L₃ is greater than the slope of L₁, the flight direction of the unmanned aerial vehicle is deflected clockwise, and if the slope of L₃ is less than the slope of L₁, the flight direction of the unmanned aerial vehicle is deflected counterclockwise.

It may be understood that in a straight flight path section, the first obtained position of the unmanned aerial vehicle is the position of the start point of the straight flight path section, and coordinates of the starting point in the Cartesian coordinate system I are (xₐ, yₐ).

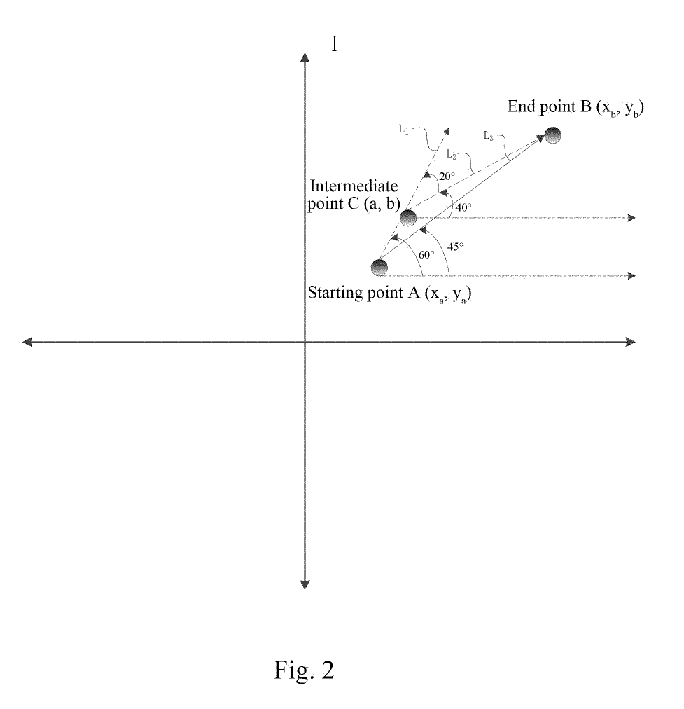

The correction method is described below in combination with specific embodiments. As shown in FIG. 2, the Cartesian coordinate system I shows the start point A (xₐ, yₐ) and the end point B (x_{b}, y_{b}) of the straight flight path section, and the linear function of L3 may be obtained based on the coordinates of the two points:

y=m_{ab}×X+n_{ab}

Here, m_{ab} and n_{ab} are constants, the slope of L₃ is m_{ab}, and the angle between L₁ and the horizontal axis of the Cartesian coordinate system I may be further obtained, for example, 45°, and the flight direction of the unmanned aerial vehicle is determined.

The unmanned aerial vehicle obtains the current position at every interval of the predetermined time T. When there is a deviation in the flight direction due to factors such as external forces (e.g., wind), and the flight reaches a first intermediate point C (xᵢ, yᵢ), the angle between a connection line between the position of the unmanned aerial vehicle at the preceding time, i.e., the start point A and the first intermediate point C, and the horizontal axis of the Cartesian coordinate system I is calculated, for example, 60°, and the angle between a connection line between the end point B and the first intermediate point C, and the horizontal axis of the Cartesian coordinate system I is calculated, for example, 40°. Then, it may be concluded that the current flight direction of the unmanned aerial vehicle has a deviation of 20° from the end point, the slope of L₁ is positive, and the slope of L₃ is less than the slope of L₁. Therefore, the unmanned aerial vehicle is deflected clockwise by 20° to complete the correction.

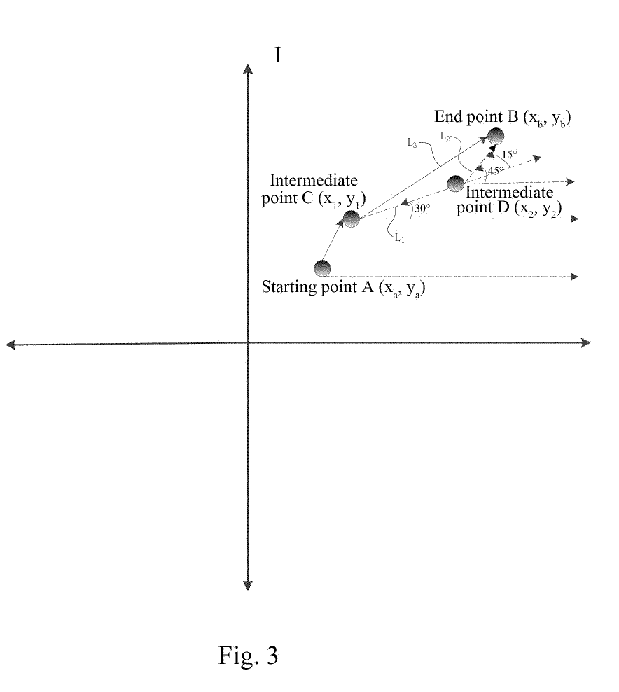

As shown in FIG. 3, the unmanned aerial vehicle further obtains the current position as the second intermediate point D (x_{z}, y_{z}). The angle between a connection line between the position of the unmanned aerial vehicle at the preceding time, i.e., the first intermediate point C and the second intermediate point D, and the horizontal axis of the Cartesian coordinate system I is calculated, for example, 30°, and the angle between a connection line between the end point B and the second intermediate point D, and the horizontal axis of the Cartesian coordinate system I is calculated, for example, 45°. Then, it may be concluded that the current flight direction of the unmanned aerial vehicle has a deviation of 15° from the end point, the slope of L₁ is positive, and the slope of L₃ is greater than the slope of L₁. Therefore, the unmanned aerial vehicle is deflected counterclockwise by 15° to complete the correction.

In a preferred embodiment, in order to reduce the number of direction adjustments as much as possible while ensuring the flight direction, a predetermined value θ may be set. Before the deflecting the flight direction of the unmanned aerial vehicle, it may be determined whether |αᵢ−βᵢ| is greater than or equal to the predetermined value θ, if yes, the flight direction of the unmanned aerial vehicle is deflected by the angle |αᵢ−βᵢ| to the end position, otherwise no deflection is performed, and the effect of reducing the energy consumption and improving the endurance of the unmanned aerial vehicle is achieved.

In a straight flight path section, the unmanned aerial vehicle obtains the coordinates of the current position in the Cartesian coordinate system I at every interval of the predetermined time T, and determines whether the flight direction of the unmanned aerial vehicle needs to be corrected, thus ensuring the flight direction of the unmanned aerial vehicle in the straight flight path section. The predetermined time T is not limited in size, and may be set according to factors such as weather conditions and environment.

In a preferred embodiment, in a straight flight path section, when there is a first predetermined distance from the end point, the predetermined time T is reduced, that is, when the end point of the straight flight path section is about to arrive, the detection interval is appropriately reduced. The predetermined time T is reduced, and the numbers of direction detections and adjustments are increased to ensure that the unmanned aerial vehicle can accurately reach the end point and prevent the unmanned aerial vehicle from exceeding the end point.

Similarly, in the entire flight path, when there is a second predetermined distance from the end point of the entire flight path of the unmanned aerial vehicle, the predetermined time T is reduced to ensure that the unmanned aerial vehicle reaches the destination accurately.

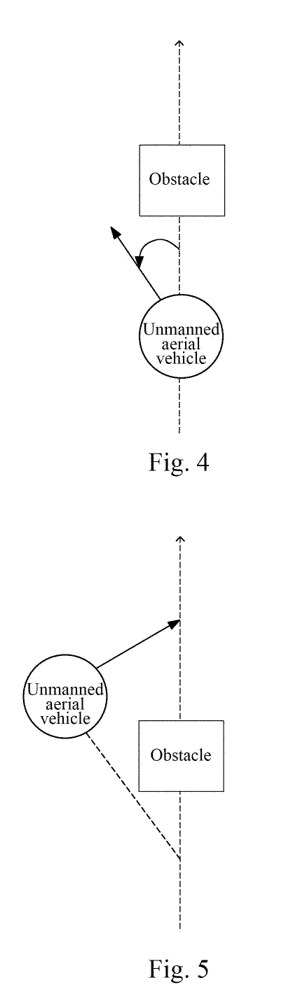

In a preferred embodiment, the unmanned aerial vehicle may encounter an obstacle during the flight, so it is necessary to perform an obstacle avoidance operation. After the obstacle is bypassed, the correction method provided by the present disclosure may be used to correct the flight direction of the unmanned aerial vehicle. For example, as shown in FIG. 4, when the unmanned aerial vehicle detects an obstacle during the flight, the unmanned aerial vehicle changes the flight direction, as shown in FIG. 5, when it is detected that the obstacle is bypassed, the above correction method is used to change the flight direction of the unmanned aerial vehicle, so that the unmanned aerial vehicle returns to the correct flight path. The specific correction method is similar to the foregoing method, and detailed description thereof will be omitted.

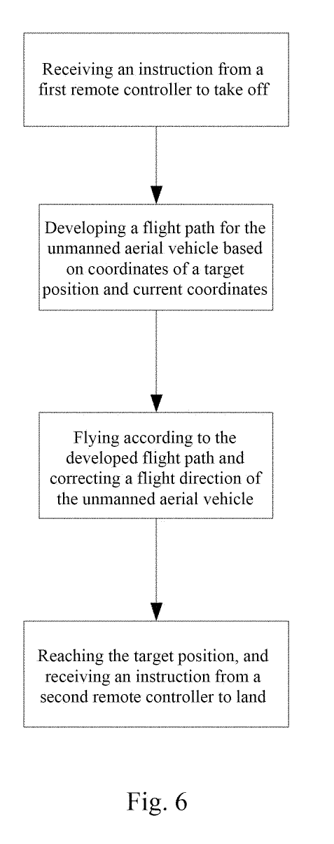

Further, the present disclosure also provides a control method for an unmanned aerial vehicle, as shown in FIG. 6, the method includes: developing a flight path for the unmanned aerial vehicle based on coordinates of a target position and current coordinates; and flying according to the developed flight path and correcting a flight direction of the unmanned aerial vehicle according to the correction method. Since the flight direction is corrected using the above correction method, the flight reliability is high and the flight path is accurate.

The flying according to the developed flight path is specifically as follows.

Establishing a Cartesian coordinate system I perpendicular to a height direction, and obtaining coordinates (xₐ₁, yₐ₁) of a starting point of a first straight flight path section of the flight path in the Cartesian coordinate system I and coordinates (x_{b1}, y_{b1}) of an end point of the first straight flight path section in the Cartesian coordinate system I.

Obtaining an initial flight direction of the unmanned aerial vehicle based on the coordinates (xₐ₁, yₐ₁) of the starting point and the coordinates (x_{b1}, y_{b1}) of the end point, and flying according to the obtained initial flight direction.

In the subsequent flight, when the unmanned aerial vehicle reaches the joint point with an adjacent straight flight path section, a connection line between the coordinates of the starting point of a preceding straight flight path section in the Cartesian coordinate system I and the coordinates of the end point of the preceding straight flight path section in the Cartesian coordinate system I is defined as L₁, a connection line between the coordinates of the starting point (i.e., the end point of the preceding straight flight path section) of a subsequent straight flight path section in the Cartesian coordinate system I and the coordinates of the end point of the subsequent straight flight path section in the Cartesian coordinate system I is defined as Lᵢ₊₁, the angle δᵢ between L₁ and the horizontal axis of the Cartesian coordinate system I is obtained, and the angle δᵢ₊₁ between Lᵢ₊₁ and the horizontal axis of the Cartesian coordinate system I is obtained. The flight direction of the unmanned aerial vehicle is deflected to the position of the end point of the subsequent straight flight path section by an angle of δᵢ+δᵢ₊₁ to enter the subsequent straight flight path section. The process similar to the correction method is adopted, therefore, the effect of improving the accuracy of the flight direction, simplifying the calculation method and improving the adjustment efficiency can be achieved.

Further, the control method further includes: when the unmanned aerial vehicle receives an instruction from a first remote controller, it performs a take-off action, and when the unmanned aerial vehicle reaches the target position, it performs a landing action after receiving an instruction from a second remote controller. A remote controller is used to control at the take-off end and the landing end, and an automatic navigation flight is adopted during the flight, the control method has high reliability and accurate flight path.

Specifically, the control method is as shown in the figure, a package deliverer (operating user A) inputs the identifier of the unmanned aerial vehicle to be controlled to a first remote controller to activate the corresponding unmanned aerial vehicle, and inputs the GPS coordinates of the specified flight destination address of the unmanned aerial vehicle through the first remote controller. The unmanned aerial vehicle performs the flight to the air through remote control, and the flight path (high dynamic GPS receiver) is developed through the current GPS and the target GPS. The user A activates the automatic cruise function of the unmanned aerial vehicle. The unmanned aerial vehicle guides the flight to the target GPS by acquiring the real time GPS coordinates by itself. When the unmanned aerial vehicle reaches the specified GPS location, a remote control user B may take over the flight control right of the unmanned aerial vehicle through a second remote controller to control the landing of the unmanned aerial vehicle.

Further, the present disclosure also provides an unmanned aerial vehicle, including: a positioning apparatus, configured to obtain, at every interval of a predetermined time T, a position of the unmanned aerial vehicle; a processing apparatus, storing flight path information of the unmanned aerial vehicle, a flight path including a plurality of straight flight path sections, and the processing apparatus is configured to correct a flight direction of the unmanned aerial vehicle according to a position of the unmanned aerial vehicle obtained at a preceding time, the position of the unmanned aerial vehicle obtained at a current time, and an end position of a straight flight path section encompassing the position of the unmanned aerial vehicle at the current time.

Here, the processing apparatus includes: a first storage unit, configured to store a Cartesian coordinate system I perpendicular to a height direction; a first acquisition unit, configured to acquire coordinates (x_{b}, y_{b}) of the end position of the straight flight path section encompassing the position of the unmanned aerial vehicle at the current time in the Cartesian coordinate system I; and a second acquisition unit, configured to acquire coordinates (xᵢ, yᵢ) of the position of the unmanned aerial vehicle obtained at the current time in the Cartesian coordinate system I.

For convenience of description, a connection line between the coordinates (xᵢ, yᵢ) of the position at the current time and the coordinates (xᵢ₋₁, yᵢ₋₁) of the position at the preceding time is defined as L₁, a connection line between the coordinates (xᵢ, yᵢ) of the position at the current time and the coordinates (x_{b}, y_{b}) of the end position is defined as L₂, and a connection line between the coordinates (xᵢ₋₁, yᵢ₋₁) of the position at the preceding time and the coordinates (x_{b}, y_{b}) of the end position is defined as L₃.

Further, the processing apparatus further includes: a first processing unit, configured to calculate an angle αᵢ between L₁ and a horizontal axis of the Cartesian coordinate system I; a second processing unit, configured to calculate an angle βᵢ between L₂ and the horizontal axis of the Cartesian coordinate system I; a third processing unit, configured to calculate to obtain a deflection angle |αᵢ−βᵢ|; and a driving unit, configured to drive the flight direction of the unmanned aerial vehicle to deflect by an angle |αᵢ−βᵢ| to the end position.

Further, the processing apparatus further includes: a first comparison unit, configured to compare a slope of L₃ with a slope of L₁; when the slope of L_{L} is positive, if the slope of L₃ is less than the slope of L₁, the driving unit drives the flight direction of the unmanned aerial vehicle to deflect clockwise, and if the slope of L₃ is greater than the slope of L₁, drives the flight direction of the unmanned aerial vehicle to deflect counterclockwise; and when the slope of L₁ is negative, if the slope of L₃ is greater than the slope of L₁, the driving unit drives the flight direction of the unmanned aerial vehicle to deflect clockwise, and if the slope of L₃ is less than the slope of L₁, drives the flight direction of the unmanned aerial vehicle to deflect counterclockwise.

Further, the processing apparatus further includes: a second comparison unit, configured to compare |αᵢ−βᵢ| with a predetermined value θ; before the unmanned aerial vehicle deflects the flight direction, the second comparison unit compares |αᵢ−βᵢ| with the predetermined value θ, and if |αᵢ−βᵢ| is greater than or equal to the predetermined value θ, the driving unit drives the unmanned aerial vehicle to deflect the flight direction, if |αᵢ−βᵢ| is less than the predetermined value θ, the driving unit does not perform the deflection.

The unmanned aerial vehicle may replace the traditional manual method by car for package delivery, which reduces the cost and improves the delivery efficiency. For some remote and special environment package delivery, it is a good method to be efficient and cost-effective.

In addition, it should be understood by those skilled in the art that the accompanying drawings are provided for the purpose of illustration, and the accompanying drawings are not strictly drawn to scale.

At the same time, it should be understood that the exemplary embodiments are provided so that the present disclosure is comprehensive and fully conveys its scope to those skilled in the art. Numerous specific details are set forth, such as examples of specific components, devices, and methods, to provide a comprehensive understanding of the present disclosure. Those skilled in the art may appreciate that without using specific details, the exemplary embodiments may be embodied in many different forms, and the exemplary embodiments are not to be construed as limiting the scope of the present disclosure. In some exemplary embodiments, well-known device structures and well-known techniques are not described in detail.

When an element or layer is referred to as “on,” “bonded to,” “connected to,” or “coupled to” another element or layer, the element or layer may be directly on, bonded, connected or coupled to another element or layer, or an intermediate element or layer may be present. In contrast, when an element is referred to as “directly on,” “directly bonded to,” “directly connected to,” or “directly coupled to” another element or layer, there may be no intermediate elements or layers. Other words used to describe the relationship between the elements should be interpreted in a similar way (e.g., “between” and “directly between”, “adjacent to” and “directly adjacent to”, etc.) The term “and/or” as used herein includes any and all combinations of one or more of the associated listed items.

Although the terms first, second, third, etc. may be used to describe various elements, components, areas, layers and/or sections, these elements, components, areas, layers and/or sections should not be limited by these terms. These terms may be only used to distinguish one element, component, area, layer or section from another element, component, area, layer or section. Terms such as “first,” “second,” and other numerical terms when used herein do not denote an order or sequence unless clearly indicated by the context. Thus, a first element, component, area, layer or section discussed below may be referred to as a second element, component, area, layer or section without departing from the teachings of the exemplary embodiments. Further, in the description of the present disclosure, the meaning of “a plurality of” is two or more unless specified otherwise.

The foregoing is only a description of the preferred embodiments of the present disclosure, and is not intended to limit the present disclosure. For those skilled in the art, various modifications and changes may be made to the present disclosure. Any modifications, equivalents, improvements, etc. made within the spirit and principles of the present disclosure are intended to be included within the scope of the present disclosure.

1. A flight direction correction method for an unmanned aerial vehicle, a flight path of the unmanned aerial vehicle comprising a plurality of straight flight path sections, the method comprising:
obtaining, at every interval of a predetermined time T, a position of the unmanned aerial vehicle in a straight flight path section; and
correcting a flight direction of the unmanned aerial vehicle according to a position of the unmanned aerial vehicle obtained at a preceding time, a position of the unmanned aerial vehicle obtained at a current time, and an end position of the straight flight path section encompassing the position of the unmanned aerial vehicle at the current time.

2. The method according to claim 1, the correcting a flight direction of the unmanned aerial vehicle comprising:
establishing a Cartesian coordinate system I perpendicular to a height direction, and obtaining coordinates (xᵢ₋₁, yᵢ₋₁) of the position of the unmanned aerial vehicle obtained at the preceding time in the Cartesian coordinate system I, coordinates (xᵢ, yᵢ) of the position of the unmanned aerial vehicle obtained at the current time in the Cartesian coordinate system I and coordinates (x_{b}, y_{b}) of the end position of the straight flight path section encompassing the position of the unmanned aerial vehicle at the current time in the Cartesian coordinate system I; and
correcting the flight direction of the unmanned aerial vehicle based on the coordinates (xᵢ₋₁, yᵢ₋₁) of the position at the preceding time, the coordinates (xᵢ, yᵢ) of the position at the current time and the coordinates (x_{b}, y_{b}) of the end position.

3. The method according to claim 2, wherein a connection line between the coordinates (xᵢ, yᵢ) of the position at the current time and the coordinates (xᵢ₋₁, yᵢ₋₁) of the position at the preceding time is defined as L₁, and a connection line between the coordinates (xᵢ, yᵢ) of the position at the current time and the coordinates (x_{b}, y_{b}) of the end position is defined as L₂;
the correcting the flight direction of the unmanned aerial vehicle based on the coordinates (xᵢ₋₁, yᵢ₋₁) of the position at the preceding time, the coordinates (xᵢ, yᵢ) of the position at the current time and the coordinates (x_{b}, y_{b}) of the end position comprises:
obtaining an angle αᵢ between L₁ and a horizontal axis of the Cartesian coordinate system I, and an angle βᵢ between L₂ and the horizontal axis of the Cartesian coordinate system I; and
deflecting the flight direction of the unmanned aerial vehicle by an angle |αᵢ−βᵢ| to the end position.

4. The method according to claim 3, wherein a connection line between the coordinates (xᵢ₋₁, yᵢ₋₁) of the position at the preceding time and the coordinates (x_{b}, y_{b}) of the end position is defined as L₃;
the deflecting the flight direction of the unmanned aerial vehicle by an angle |αᵢ−βᵢ| to the end position comprises:
wherein, when a slope of L₁ is positive, if a slope of L₃ is less than the slope of L₁, the flight direction of the unmanned aerial vehicle is deflected clockwise, and if the slope of L₃ is greater than the slope of L₁, the flight direction of the unmanned aerial vehicle is deflected counterclockwise; and
when the slope of L₁ is negative, if the slope of L₃ is greater than the slope of L₁, the flight direction of the unmanned aerial vehicle is deflected clockwise, and if the slope of L₃ is less than the slope of L₁, the flight direction of the unmanned aerial vehicle is deflected counterclockwise.

5. The method according to claim 3, before the deflecting the flight direction of the unmanned aerial vehicle, determining whether |αᵢ−βᵢ| is greater than or equal to a predetermined value θ, if |αᵢ−βᵢ| is greater than or equal to the predetermined value θ, the flight direction of the unmanned aerial vehicle is deflected by the angle |αᵢ−βᵢ| to the end position, if |αᵢ−βᵢ| is less than the predetermined value θ, no deflection is performed.

6. The method according to claim 1, wherein in a straight flight path section, at a first predetermined distance from an end point of the straight flight path section, the predetermined time T is reduced; and/or
at a second predetermined distance from an end point of the entire flight path of the unmanned aerial vehicle, the predetermined time T is reduced.

7. The method according to claim 1, wherein the unmanned aerial vehicle changes the flight direction when an obstacle is detected, and the flight direction of the unmanned aerial vehicle is corrected using the correction method, after detecting bypassing the obstacle.

8. A control method for an unmanned aerial vehicle, the method comprising:
developing a flight path for the unmanned aerial vehicle based on coordinates of a target position and current coordinates; and
flying according to the developed flight path and correcting a flight direction of the unmanned aerial vehicle according to the correction method according to claim 1.

9. The method according to claim 8, wherein the developed flight path comprises a plurality of straight flight path sections, and the flying according to the developed flight path comprises:
establishing the Cartesian coordinate system I perpendicular to the height direction, and obtaining coordinates (xₐ₁, yₐ₁) of a starting point of a first straight flight path section of the flight path in the Cartesian coordinate system I and coordinates (x_{b1}, y_{b1}) of an end point of the first straight flight path section in the Cartesian coordinate system I; and
obtaining an initial flight direction of the unmanned aerial vehicle based on the coordinates (xₐ₁, yₐ₁) of the starting point and the coordinates (x_{b1}, y_{b1}) of the end point, and flying according to the obtained initial flight direction.

10. The method according to claim 9, wherein the flying according to the developed flight path further comprises:
when the unmanned aerial vehicle reaches a joint point with an adjacent straight flight path section, a connection line between coordinates of a starting point of a preceding straight flight path section in the Cartesian coordinate system I and coordinates of an end point of the preceding straight flight path section in the Cartesian coordinate system I is defined as Lᵢ, a connection line between coordinates of a starting point of a subsequent straight flight path section in the Cartesian coordinate system I and coordinates of an end point of the subsequent straight flight path section in the Cartesian coordinate system I is defined as Lᵢ₊₁, obtaining an angle δᵢ between Lᵢ and a horizontal axis of the Cartesian coordinate system I and an angle δᵢ₊₁ between Lᵢ₊₁ and the horizontal axis of the Cartesian coordinate system I, deflecting the flight direction of the unmanned aerial vehicle to a position of the end point of the subsequent straight flight path section by an angle of δᵢ+δᵢ₊₁ to enter the subsequent straight flight path section.

11. The method according to claim 9, further comprising:
receiving an instruction from a first remote controller to take off; and
reaching the target position, and receiving an instruction from a second remote controller to land.

12. An unmanned aerial vehicle, a flight path of the unmanned aerial vehicle comprising a plurality of straight flight path sections, the unmanned aerial vehicle comprising:
at least one processor; and
a memory storing instructions, the instructions when executed by the at least one processor, cause the at least one processor to perform operations, the operations comprising:
obtaining, at every interval of a predetermined time T, a position of the unmanned aerial vehicle;
correcting a flight direction of the unmanned aerial vehicle according to a position of the unmanned aerial vehicle obtained at a preceding time, a position of the unmanned aerial vehicle obtained at a current time, and an end position of a straight flight path section encompassing the position of the unmanned aerial vehicle at the current time.

13. (canceled)

14. A non-transitory computer storage medium, storing computer readable instructions executable by a processor, the computer readable instructions, when executed by the processor, cause the processor to perform operations, the operations comprising:
obtaining, at every interval of a predetermined time T, a position of the unmanned aerial vehicle in a straight flight path section; and
correcting a flight direction of the unmanned aerial vehicle according to a position of the unmanned aerial vehicle obtained at a preceding time, a position of the unmanned aerial vehicle obtained at a current time, and an end position of the straight flight path section encompassing the position of the unmanned aerial vehicle at the current time.

15. The unmanned aerial vehicle according to claim 12, the correcting a flight direction of the unmanned aerial vehicle comprising:
establishing a Cartesian coordinate system I perpendicular to a height direction, and obtaining coordinates (xᵢ₋₁, yᵢ₋₁) of the position of the unmanned aerial vehicle obtained at the preceding time in the Cartesian coordinate system I, coordinates (xᵢ, yᵢ) of the position of the unmanned aerial vehicle obtained at the current time in the Cartesian coordinate system I and coordinates (x_{b}, y_{b}) of the end position of the straight flight path section encompassing the position of the unmanned aerial vehicle at the current time in the Cartesian coordinate system I; and
correcting the flight direction of the unmanned aerial vehicle based on the coordinates (xᵢ₋₁, yᵢ₋₁) of the position at the preceding time, the coordinates (xᵢ, yᵢ) of the position at the current time and the coordinates (x_{b}, y_{b}) of the end position.

16. The unmanned aerial vehicle according to claim 15, wherein a connection line between the coordinates (xᵢ, yᵢ) of the position at the current time and the coordinates (xᵢ₋₁, yᵢ₋₁) of the position at the preceding time is defined as L₁, and a connection line between the coordinates (xᵢ, yᵢ) of the position at the current time and the coordinates (x_{b}, y_{b}) of the end position is defined as L₂;
the correcting the flight direction of the unmanned aerial vehicle based on the coordinates (xᵢ₋₁, yᵢ₋₁) of the position at the preceding time, the coordinates (xᵢ, yᵢ) of the position at the current time and the coordinates (x_{b}, y_{b}) of the end position comprises:
obtaining an angle αᵢ between L₁ and a horizontal axis of the Cartesian coordinate system I, and an angle βᵢ between L₂ and the horizontal axis of the Cartesian coordinate system I; and
deflecting the flight direction of the unmanned aerial vehicle by an angle |αᵢ−βᵢ| to the end position.

17. The unmanned aerial vehicle according to claim 16, wherein a connection line between the coordinates (xᵢ₋₁, yᵢ₋₁) of the position at the preceding time and the coordinates (x_{b}, y_{b}) of the end position is defined as L₃;
the deflecting the flight direction of the unmanned aerial vehicle by an angle |αᵢ−βᵢ| to the end position comprises:
wherein, when a slope of L₁ is positive, if a slope of L₃ is less than the slope of L₁, the flight direction of the unmanned aerial vehicle is deflected clockwise, and if the slope of L₃ is greater than the slope of L₁, the flight direction of the unmanned aerial vehicle is deflected counterclockwise; and
when the slope of L₁ is negative, if the slope of L₃ is greater than the slope of L₁, the flight direction of the unmanned aerial vehicle is deflected clockwise, and if the slope of L₃ is less than the slope of L₁, the flight direction of the unmanned aerial vehicle is deflected counterclockwise.

18. The unmanned aerial vehicle according to claim 16, before the deflecting the flight direction of the unmanned aerial vehicle, determining whether |αᵢ−βᵢ| is greater than or equal to a predetermined value θ, if |αᵢ−βᵢ| is greater than or equal to the predetermined value θ, the flight direction of the unmanned aerial vehicle is deflected by the angle |αᵢ−βᵢ| to the end position, if |αᵢ−βᵢ| less than the predetermined value θ, no deflection is performed.

19. The unmanned aerial vehicle according to claim 12, wherein in a straight flight path section, at a first predetermined distance from an end point of the straight flight path section, the predetermined time T is reduced; and/or
at a second predetermined distance from an end point of the entire flight path of the unmanned aerial vehicle, the predetermined time T is reduced.

20. The unmanned aerial vehicle according to claim 12, wherein the unmanned aerial vehicle changes the flight direction when an obstacle is detected, and the flight direction of the unmanned aerial vehicle is corrected using the correction method, after detecting bypassing the obstacle.
